(19) United States
(12) Patent Application Publication
(10) Pub. No.: US 2025/0355266 A1
(43) Pub. Date: Nov. 20, 2025

(54) OPTICAL ELEMENTS PROVIDING COLLIMATION AND FAN-OUT OR DIFFUSION

(71) Applicant: NIL Technology ApS, Kongens Lyngby (DK)

(72) Inventors: Olivier Francois, Kongens Lyngby (DK); Yuriy Elesin, Copenhagen (DK)

(21) Appl. No.: 18/868,333

(22) PCT Filed: May 30, 2023
(86) PCT No.: PCT/EP2023/064452

§ 371 Date: Nov. 22, 2024

Related U.S. Application Data
(60) Provisional application No. 63/348,847, filed on Jun. 3, 2022.

(51) Int. Cl. G02B 27/09; G02B 27/10; G02B 27/30; G02B 27/42

(52) U.S. Cl. CPC G02B 27/0944; G02B 27/0905; G02B 27/1086; G02B 27/30; G02B 27/425

(57) ABSTRACT

The present disclosure describes optical elements, as well as methods for designing and fabricating such optical elements. An example apparatus includes an optical element having a first surface and a second surface, wherein the first and second surfaces are on opposite sides of the optical element from one another. The first surface is structured to collimate a light beam incident on the first surface, and the second surface is structured to provide correction to collimation imparted by the first surface and to provide at least one of optical fan-out or diffusion for the light beam.

### FIELD OF THE DISCLOSURE

The present disclosure relates to optical elements for dot projection and the like.

### BACKGROUND

Various consumer products are designed to be able to recognize or navigate around their surroundings. For example, some smartphones provide face recognition using an infra-red (IR) dot projector that serves as a structured light emitter. The projector produces a pattern of infrared dots in front of the smartphone, which can illuminate a face or other object so that it can be photographically captured by the camera. The dot projector can include, for example, an array of light emitting units, lenses, and beam splitters. The lenses and beam splitters generate duplications of the array source pattern, and project a duplicated pattern of dots onto a person's face or other object. An infrared camera can capture the pattern to be used in a structured light algorithm to detect the three-dimensional (3D) shape of the face or other object.

### SUMMARY

The present disclosure describes optical elements that can be used, for example, for dot projection and/or flood illumination, as well as methods for designing and fabricating such optical elements.

For example, the present disclosure describes an apparatus that includes an optical element having a first surface and a second surface, wherein the first and second surfaces are on opposite sides of the optical element from one another. The first surface is structured to collimate a light beam incident on the first surface, and the second surface is structured to provide correction to collimation imparted by the first surface and to provide at least one of optical fan-out or diffusion for the light beam.

Some implementations include one or more of the following features. For example, in some implementations, a structure of the first surface that is operable to collimate the light beam has more high-frequency components than a structure of the second surface that is operable to provide the correction to the collimation imparted by the first surface. In some implementations, a structure of the first surface that is operable to collimate the light beam corresponds to a first component of a phase function, and a structure of the second surface that is operable to provide the correction to the collimation imparted by the first surface corresponds to a second component of the phase function, wherein a maximum gradient of the first component of the phase function is less than a maximum gradient of the second component of the phase function. In some instances, a maximum amplitude of the second component of the phase function is less than a maximum amplitude of the first component of the phase function. For example, in some instances, the maximum amplitude of the second component of the phase function is no more than 10% of the maximum amplitude of the first component of the phase function.

In some implementations, the optical fan-out is provided by a discrete periodic surface relief structure on the second surface, and can split the light beam into a predetermined number of diffractive orders at respective angles. In some implementations, the optical diffusion is provided by a discrete non-periodic surface relief structure on the second surface,

[symbol]

In some implementations, the apparatus further includes a light emitter operable to emit light toward the first surface of the optical element, wherein the optical element is disposed so that the light passes through the optical element, and the optical element projects a pattern using the light.

The present disclosure also describes a method that includes splitting a phase function into first and second components, wherein the first component represents collimation to be implemented on a first surface of an optical element, and the second component represents a collimation correction to be implemented on a second surface of the optical element. The method includes combining at least one of a fan-out phase function or a diffuser phase function with the second component of the collimator phase function to obtain a combined phase function, determining a first optical element structure corresponding to the first component of the collimator phase function, and determining a second optical element structure corresponding to the combined phase function. The method further includes fabricating an optical device including a substrate that has a first surface and a second surface respectively on opposite sides of the substrate, wherein the first optical element structure is on the first surface, and wherein the second optical element structure is on the second surface.

In some implementations, instead of combining the fan-out phase function with the second component of the collimator phase function to obtain a combined phase function, the corresponding optical element structures are combined. For example, the present disclosure also describes a method that includes splitting a phase function into first and second components, wherein the first component represents collimation to be implemented on a first surface of an optical element, and the second component represents a collimation correction to be implemented on a second surface of the optical element. The first component of the collimator phase function is converted to a corresponding first optical element structure, and the second component of the phase function is converted to a corresponding second optical element structure. The method includes combining a fan-out structure with the second optical element structure to obtain a combined optical element structure. The method further includes fabricating an optical device including a substrate that has a first surface and a second surface respectively on opposite sides of the substrate, wherein the first optical element structure in on the first surface, and wherein the combined optical element structure is on the second surface.

Some implementations of the methods include one or more of the following features. For example, in some cases, a maximum gradient of the first component of the phase function is less than a maximum gradient of the second component of the phase function. In some instances, a maximum amplitude of the second component of the phase function is less than a maximum amplitude of the first component of the phase function. For example, in some cases, the maximum amplitude of the second component of the phase function is no more than 10% of the maximum amplitude of the first component of the phase function. In some implementations, the first diffractive optical element structure for the collimation has more high-frequency components than the second diffractive optical element structure for providing the correction to the collimation.

In some implementations, the method further includes, before combining the fan-out phase function with the second component of the collimator phase function to obtain a combined phase function, converting a fan-out structure to a corresponding fan-out phase function. Subsequently, the corresponding fan-out phase function is used as the fan-out phase function that is combined with the second component of the collimator phase function.

In some implementations, fabricating the optical device includes forming the first and second optical element structures, respectively, on the first and second surfaces of the substrate by nano wafer-level replication.

Other aspects, features and advantages will be readily apparent from the following detailed description, the accompanying drawings and the claims.

### BRIEF DESCRIPTION OF THE DRAWINGS

FIG. 1 illustrates an example of an optical element that provides both collimator and fan-out functions.

FIG. 2 illustrates an example operation of the optical element of FIG. 1.

FIG. 3 is a flow chart illustrating an example method of designing and manufacturing the optical element of FIG. 1.

FIG. 4 illustrates an example of two components of a collimator phase function.

FIG. 5A illustrates an example DOE structure corresponding to a first component of the collimator phase function.

FIG. 5B illustrates an example DOE structure corresponding to a second component of the collimator phase function.

FIG. 6 illustrates an example fan-out structure.

FIG. 7 illustrates an example of a phase function corresponding to the fan-out structure of FIG. 6.

FIG. 8 illustrates an example of an optical dot projector.

### DETAILED DESCRIPTION

Dot projectors sometimes use an array of light emitters (e.g., an array of vertical cavity surface emitting lasers (VCSLEs)) as light sources. The light emitted by the VCSELs typically diverges strongly and should be collimated. Thus, a dot projector may include one or more diffractive optical elements (DOEs) to collimate the light from the VCSELs prior to passing the light through a fan-out diffractive optical element (e.g., a fan-out diffractive beam splitter).

In accordance with the present disclosure, a single optical element is described that provides both functions: that is, the optical element serves to collimate an incident light beam and also provides fan-out to create multiple optical beams by deflecting the incident light into different diffraction orders. In particular, the optical element is structured such that the collimation function is split between two of the optical element's surfaces, and one of those surfaces also provides the fan-out function. For example, both the front and rear surfaces of the optical element can serve, collectively, to collimate the incident light, and the rear surface also can provide the fan-out function. In some implementations, the optical element is structured such that the front surface provides most of the collimation, whereas the rear surface provides collimation correction as well as the fan-out.

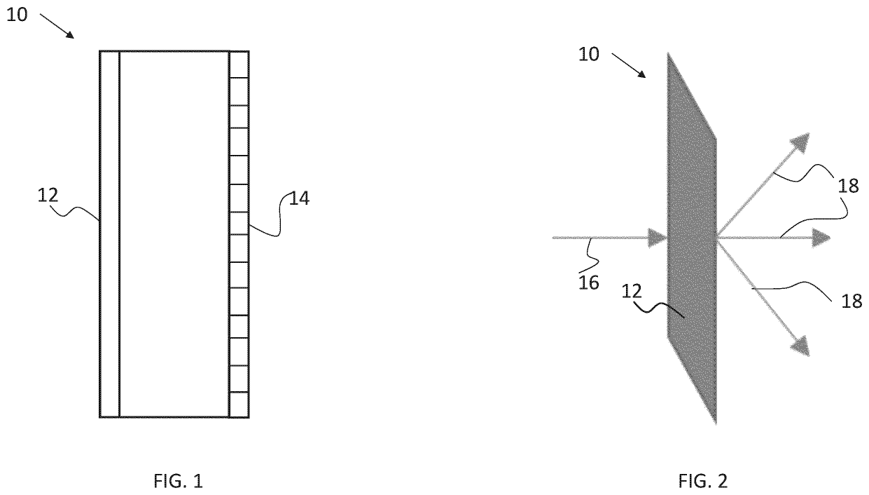

FIG. 1 illustrates an example of an optical element 10 having a first (e.g., front) surface 12 and a second (e.g., rear) surface 14. The first and second surfaces 12, 14 are on opposite sides of the optical element 10. The first surface 12 can be structured so as to substantially collimate one or more light beams incident on the first surface 12. The second surface 14 is structured to provide corrections to the collimation imparted by the first surface 12, and to provide a fan-out function (i.e., to create multiple optical beams by deflecting the incident light into different diffraction orders). Aspects of the following refer to a diffractive optical element (DOE) as an example of the optical element 10. However, in some implementations, the optical element 10 can be a meta optical element (MOE).

In some implementations, the collimating structure on the first surface 12 includes high spatial frequencies, whereas the structure on the second surface providing the collimation correction consists of lower spatial frequencies that are less likely to significantly perturb or interfere with the fan-out function of the second surface.

As illustrated by FIG. 2, in use, each light beam 16 incident on the first surface 12 passes through the optical element 10, and multiple diffraction orders 18 exit through the second surface 14. The single optical element 10 can provide both collimating and fan-out functions for incident light (e.g., light beams emitted by an array of VCSELs). As noted above, however, the collimating function is split between the two surfaces 12, 14, with collimation correction being provided by the structure of the second surface 14.

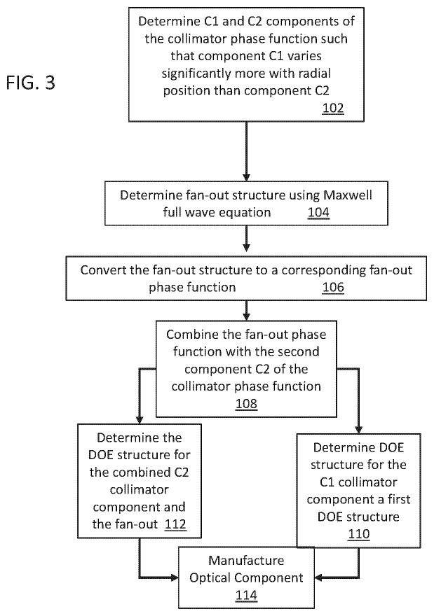

FIG. 3 is a flow chart illustrating a method of designing and manufacturing an optical element 10 as described above. It is assumed that the collimating function of the optical element 10 is designed to have a certain phase function. Then, as indicated by 102, the phase function is split into two components, C1 and C2. The first component C1 can represent, for example, the main collimation to be implemented on the first surface 12 of the optical element, whereas the second component C2 can represent the collimation correction to be implemented on the second surface 14 of the optical element. Preferably, the second component C2 should have a maximum gradient (i.e., slope) that is relatively low. For example, the second component C2 can have a maximum gradient that is significantly less than the gradient of the first component C1 and can vary significantly less with radial position than the first component C1. That is, the second component C2 of the phase function should vary relatively slowly. One way to achieve this constraint is to define a maximum amplitude for the second component C2 of the phase function relative to the maximum amplitude of the first component C1. For example, in some implementations, the maximum amplitude for the second component C2 is set to be no more than a specified percentage (e.g., 10%) of the maximum amplitude for the first component C1. As the maximum amplitude of the second component C2 is relatively small, the maximum gradient of the second component C2 also will be relatively low.

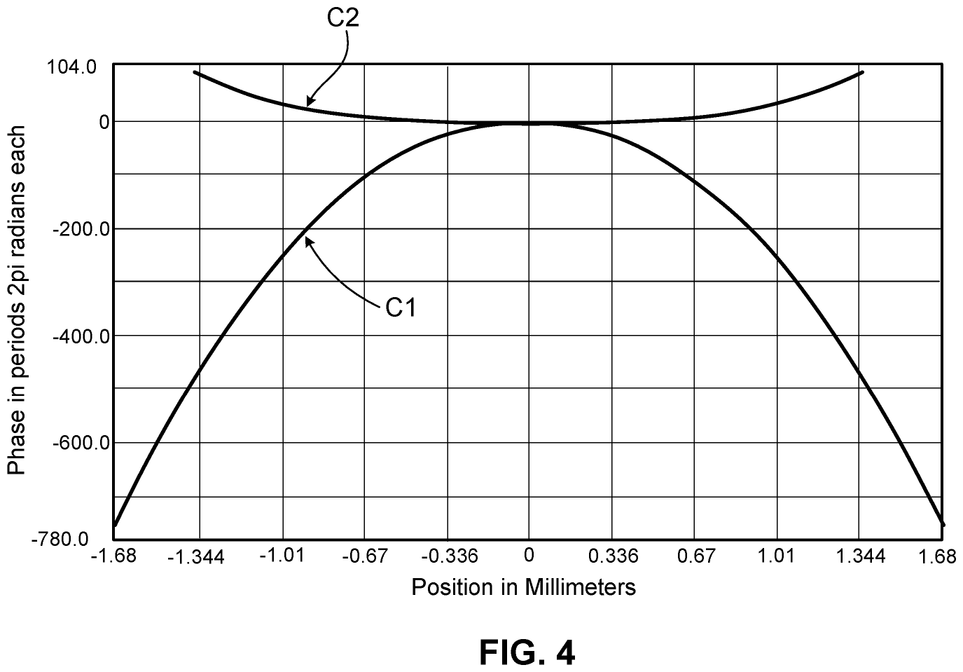

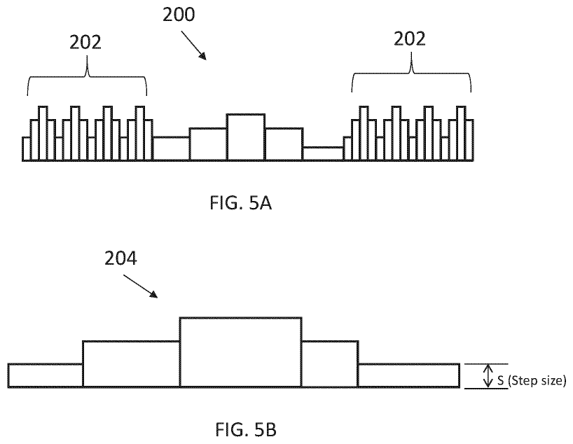

FIG. 4 illustrates an example of the first component C1 and the second component C2 of the phase function for implementing collimation in the optical element 10. A physical structure 200 corresponding to the first component C1 of the phase function (see FIG. 5A) would have more higher-frequency components 202 than the physical structure 204 corresponding to the second component C2 of the phase function (see FIG. 5B). This allows the physical structure for the second component C2 of the phase function to be treated as if it were relatively flat such that it is unlikely to significantly perturb or interfere with the fan-out function with which it subsequently is combined.

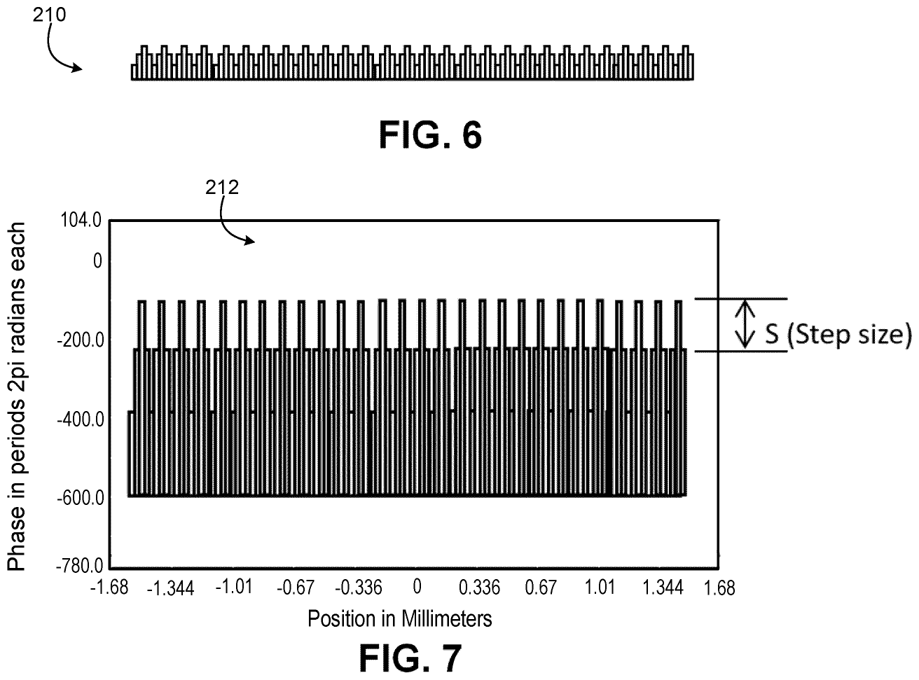

The fan-out function on the second surface 14 can be provided, for example, by a discrete periodic surface relief structure having a two-dimensional (x, y) shape. The fan-out structure can be designed, for example, to split a light beam into a specified number (e.g., three) of diffractive orders at specified angles. As indicated by 104 (FIG. 3), for situations in which the fan-out structure is periodic, and the feature size and unit cell size are relatively small, the physical structure for the fan-out can be determined, for example, using Maxwell's full wave equation. FIG. 6 illustrates an example of the fan-out structure 210. If the unit cells are relatively large, a scalar diffraction approximation of Maxwell's full wave equation can be used.

In some implementations, the second surface can be structured to provide correction to collimation imparted by the first surface and to provide diffusion for the light beam. The optical diffusion ca be provided, for example, by a discrete non-periodic surface relief structure on the second surface.

Next, as indicated by 106 (FIG. 3), the fan-out structure 201 is converted to a corresponding fan-out phase function such that the vertical steps are the same as for the second component C2 of the collimator phase function. That is, there is a correspondence between the height of the structure and the phase delay that would be introduced at the operating wavelength. FIG. 7 illustrates an example of the fan-out phase function 212 corresponding to the fan-out structure of FIG. 6.

Next, as indicated by 108 (FIG. 3), the fan-out phase function 212 (or the diffusion function) is combined with the second component C2 of the collimator phase function to obtain a combined phase function. It is possible, for example, to combine the fan-out (or diffusion) phase function with the second component C2 of the collimating phase function, without significantly perturbing the fan-out phase function, because the high-frequency components of the collimating phase function have been parsed out and included in the first component C1 of the collimator phase function. As noted above, parsing out the high-frequency components of the collimator phase function can help reduce the extent to which the fan-out phase function is perturbed (e.g., such that the fan-out structure would no longer be periodic).

Next, as indicated by 110 (FIG. 3), a first DOE structure implementing the first component C1 of the collimator phase function is determined. Likewise, as indicated by 112 (FIG. 3), a second DOE structure implementing the combined phase function is determined (i.e., a DOE structure corresponding to the combination of the fan-out phase function 212 (or the diffusion function) and the second component C2 of the collimator phase function).

Then, as indicated by 114, an optical device 10, including the first DOE structure on its first surface 12 and including the second DOE structure on its second surface 14, can be fabricated. In some implementations, the optical device 10 can be fabricated using polymer-on-glass technology. For example, the device 10 can be composed of a glass substrate having DOE structures on the first and second surfaces 12, 14 formed by nano wafer-level replication.

In some implementations, the operations of converting the fan-out structure 201 to a corresponding fan-out phase function (106 in FIG. 3) and then combining the fan-out phase function 212 with the second component C2 of the collimator phase function (108 in FIG. 3) can be omitted. Instead, the second component C2 of the collimator phase function can be converted to a corresponding DOE structure 204 (see, e.g., FIG. 5B), and that DOE structure can be combined with the fan-out structure. That is, rather than combining the phase functions for the fan-out and second component C2, their corresponding structures are combined. For example, the fan-out structure can be designed to be provided directly on the structure corresponding to the second component C2 of the collimator phase function.

Although aspects of the foregoing description refer to a DOE as an example of the optical element 10, in some implementations, the optical element 10 can be a meta optical element (MOE). Thus, for example, in some implementations, an apparatus in accordance with the present disclosure can include a meta optical element (MOE) having a first surface and a second surface, wherein the first and second surfaces are on opposite sides of the MOE from one another. The first surface can be structured to collimate a light beam incident on the first surface, and the second surface being structured to provide correction to collimation imparted by the first surface and to provide optical fan-out for the light beam.

The optical structures described above can be used, for example, in dot projectors for 3D sensing, LiDAR, and/or machine vision applications targeting consumer electronics, industrial, Internet of Things (IoT), medical, and/or automotive markets. They can be particularly well suited for industries where excellent performance, superior light control, lightweight, and compact design are required. Examples of other consumer products that may incorporate a dot projector include robotic vacuum cleaners and lawn mowers, machine vision applications (e.g., augmented reality and virtual reality), as well as autonomous guided vehicles (AGVs). Further, in some implementations, the optical structures can function as a diffuser incorporated, for example, into a flood illuminator for standard imaging and/or for 3D sensing.

Various aspects of the subject matter and the functional operations described in this specification (e.g., operations described in connection with FIGS. 3-7) can be implemented in digital electronic circuitry, or in computer software, firmware, or hardware. Thus, aspects of the subject matter described in this specification can be implemented, for example, as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The apparatus can include, in addition to hardware, code that creates an execution environment for the computer program in question, e.g., code that constitutes processor firmware.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

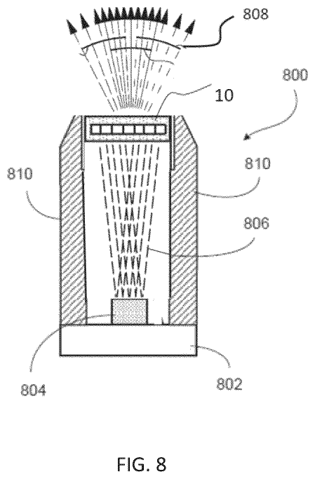

FIG. 8 illustrates an example of an optical dot projector 800. The dot projector 800 includes a substrate 802 and a light emitter 804 mounted on, or integrated in, the substrate 802. The light emitter 804 may include, for example, one or more lasers (e.g., vertical-cavity surface-emitting lasers) or light emitting diodes. Light (e.g., infra-red) 806 generated by the light emitter 804 passes through a DOE 10 and out of the dot projector. The DOE 10 may be implemented, for example, as the optical device described above in connection with FIGS. 1 and 2. The DOE 10 is disposed so as to intersect a path of the outgoing light 806 and is operable to collimate the light 806 and to split it into multiple diffractive orders 808 so that the dot projector 800 projects a pattern of dots onto an object external to the projector 800 (e.g., a person's face).

While this document contains many specific implementation details, these should not be construed as limitations on the scope of any inventions or of what may be claimed, but rather as descriptions of features specific to particular embodiments. Certain features that are described in this document in the context of separate embodiments also can be implemented in combination in a single embodiment. Conversely, various features that are described in the context of a single embodiment also can be implemented in multiple embodiments separately or in any suitable subcombination. Various modifications can be made to the foregoing examples. For example, steps indicated as being performed in a particular order may be performed in a different order or at the same time. Accordingly, other implementations also are within the scope of the claims.

1. An apparatus comprising:
an optical element having a first surface and a second surface, wherein the first and second surfaces are on opposite sides of the optical element from one another,
the first surface being structured to collimate a light beam incident on the first surface, and
the second surface being structured to provide correction to collimation imparted by the first surface and to provide at least one of optical fan-out or diffusion for the light beam.

2. The apparatus of claim 1 wherein a structure of the first surface that is operable to collimate the light beam has more high-frequency components than a structure of the second surface that is operable to provide the correction to the collimation imparted by the first surface.

3. The apparatus of claim 1 wherein a structure of the first surface that is operable to collimate the light beam corresponds to a first component of a phase function, and a structure of the second surface that is operable to provide the correction to the collimation imparted by the first surface corresponds to a second component of the phase function, wherein a maximum gradient of the first component of the phase function is less than a maximum gradient of the second component of the phase function.

4. The apparatus of claim 3 wherein a maximum amplitude of the second component of the phase function is less than a maximum amplitude of the first component of the phase function.

5. The apparatus of claim 4 wherein the maximum amplitude of the second component of the phase function is no more than 10% of the maximum amplitude of the first component of the phase function.

6. The apparatus of claim 1, wherein the second surface is structured to provide optical fan-out for the light beam, and wherein the optical fan-out is provided by a discrete periodic surface relief structure on the second surface.

7. The apparatus of claim 1, wherein the second surface is structured to provide diffusion for the light beam, and wherein the diffusion is provided by a discrete non-periodic surface relief structure on the second surface.

8. The apparatus of claim 1, wherein the second surface is structured to provide optical fan-out for the light beam, and wherein the optical fan-out is operable to split the light beam into a predetermined number of diffractive orders at respective angles.

9. The apparatus of claim 1, further including:
a light emitter operable to emit light toward the first surface of the optical element,
wherein the optical element is disposed so that the light passes through the optical element, and the optical element projects a pattern using the light.

10. A method comprising:
splitting a phase function into first and second components, wherein the first component represents collimation to be implemented on a first surface of an optical element, and the second component represents a collimation correction to be implemented on a second surface of the optical element;
combining at least one of a fan-out phase function or a diffusion phase function with the second component of the collimator phase function to obtain a combined phase function;
determining a first optical element structure corresponding to the first component of the collimator phase function;
determining a second optical element structure corresponding to the combined phase function; and
fabricating an optical device including a substrate that has a first surface and a second surface respectively on opposite sides of the substrate, wherein the first optical element structure is on the first surface, and wherein the second optical element structure is on the second surface.

11. The method of claim 10 wherein a maximum gradient of the first component of the phase function is less than a maximum gradient of the second component of the phase function.

12. The method of claim 11 wherein a maximum amplitude of the second component of the phase function is less than a maximum amplitude of the first component of the phase function.

13. The method of claim 12 wherein the maximum amplitude of the second component of the phase function is no more than 10% of the maximum amplitude of the first component of the phase function.

14. The method of claim 10, wherein the first optical element structure for the collimation has more high-frequency components than the second optical element structure for providing the correction to the collimation.

15. The method of claim 10, including combining the fan-out phase function with the second component of the collimator phase function to obtain the combined phase function, the method further including:
before combining the fan-out phase function with the second component of the collimator phase function to obtain a combined phase function, converting a fan-out structure to a corresponding fan-out phase function; and
subsequently using the corresponding fan-out phase function as the fan-out phase function that is combined with the second component of the collimator phase function.

16. The method of claim 10, wherein fabricating the optical device includes forming the first and second optical element structures, respectively, on the first and second surfaces of the substrate by nano wafer-level replication.

17. A method comprising:
splitting a phase function into first and second components, wherein the first component represents collimation to be implemented on a first surface of an optical element, and the second component represents a collimation correction to be implemented on a second surface of the optical element;
converting the first component of the collimator phase function to a corresponding first optical element structure;
converting the second component of the phase function to a corresponding second optical element structure;
combining a fan-out structure with the second optical element structure to obtain a combined optical element structure;
fabricating an optical device including a substrate that has a first surface and a second surface respectively on opposite sides of the substrate, wherein the first optical element structure in on the first surface, and wherein the combined optical element structure is on the second surface.

18. The method of claim 17 wherein a maximum gradient of the first component of the phase function is less than a maximum gradient of the second component of the phase function.

19. The method of claim 18 wherein a maximum amplitude of the second component of the phase function is less than a maximum amplitude of the first component of the phase function.

20. The method of claim 19 wherein the maximum amplitude of the second component of the phase function is no more than 10% of the maximum amplitude of the first component of the phase function.

21. The method of claim 17, wherein fabricating the optical device includes forming the first and combined optical element structures, respectively, on the first and second surfaces of the substrate by nano wafer-level replication.
